(19) United States
(12) Patent Application Publication
(10) Pub. No.: US 2009/0173012 A1
(43) Pub. Date: Jul. 9, 2009

(54) Adjustable removable restraining stop for double hung windows

(76) Inventors: Alex Luca, Valley Stream, NY (US); Daniel Luca, Valley Stream, NY (US)

Correspondence Address: ALFRED M. WALKER, 225 OLD COUNTRY ROAD, MELVILLE, NY, 11747-2712, US

(21) Appl. No.: 12/317,722

(22) Filed: Dec. 26, 2008

Related U.S. Application Data
(60) Provisional application No. 61/009,588, filed on Dec. 28, 2007.

(51) Int. Cl. E05F 3/00

(52) U.S. Cl. 49/503; 49/506

(57) ABSTRACT

An adjustable restraining stop assembly permits a residential double hung window to be locked in a partially opened position to permit ventilation through the partial opening. The stop includes an outer tube with a telescoping inner tube. The outer tube is mounted to a window sash by a removable fixation device, such as a mounting hook and loop arrangement. A convenience knob is attached near the distal end of the inner tube. Adjustment is set by placing a desired hole of a plurality of holes in the telescoping inner tube in registration with a single hole in the outer tube and then inserting the end of a fastener, such as a cotter pin, locking both tubes together.

### RELATED APPLICATIONS

This application is based upon provisional application Ser. No. 61/009,588 filed Dec. 28, 2007 and claims priority under 35 U.S.C. § 119(e) therefrom, and is incorporated by reference herein.

### FIELD OF THE INVENTION

The present invention relates to adjustable restraining stops for double hung windows which permit the window to be partially open for ventilation but locked from further opening.

### BACKGROUND OF THE INVENTION

Double hung windows can be opened for ventilation from the top or bottom. While most windows have locks which are operable when the windows are closed, a partially open window is often left without recourse to locking. Some windows have built-in restraints to permit locking to prevent opening more than a certain fixed amount. Auxiliary screw operated locks which must be screwed into window frames are also well known, but rental apartments often disallow such modifications. An adhesively-mounted removable retrofit adjustable restraining stop for double hung windows is not known in the prior art.

### OBJECTS OF THE INVENTION

It is therefore an object of the present invention to provide an adjustable restraining stops for double hung windows which permit the window to be partially open for ventilation but locked from further opening.

It is also an object of the present invention to provide a window stop which does not need to physically alter the window frame.

Other objects which become apparent from the following description of the present invention.

### SUMMARY OF THE INVENTION

In keeping with these objects and others which may become apparent, the present invention provides an adjustable removable restraining stop for double hung windows in the form of a telescoping assembly that can be adjusted in steps to restrain a window from opening beyond a desired extent. The assembly itself is attached to the window via a large-area robust hook and loop pad with the hook portion conveniently attached to the window or sash frame via a pressure sensitive adhesive layer that is exposed upon peeling off a release liner layer. As such, the assembly can be removed to permit unencumbered opening of the window and replaced whenever the security feature is desired. Hook and loop pads of several square inches of area and of aggressive design have sufficient shear resistance to provide the desired degree of security in this application, but the two mating surfaces can still be peeled by twisting. No tools whatsoever are required for installation. The telescoping sections include a larger rectangular or square tubing section that is attached via the hook and loop pad, and a close-fitting inner tube of smaller dimension that telescopes from one end of the larger tubular section with some frictional resistance. Although the preferred material is polyvinylchloride (PVC), other materials such as aluminum can be used. The inner tube has a series of holes in a linear array on the front surface (opposite the mounting pad), while the outer tube has a single hole adjacent its end that is in registration with any in the series of holes as the inner tube is pushed in or out. A cotter pin on a short lanyard is used to lock in the desired assembly length by passing it through the single hole in the larger outer tube and then through one of the holes in the inner tube.

By attaching the assembly to the frame of the top window sash near the top, a constrained opening can be adjusted at the top of the window, the bottom, or the open space can be shared as desired between top and bottom.

In an alternate embodiment, the hole in the outer tube as well as the series of holes in the inner tube are moved to the side surface to afford more clearance for a ring-grip quick release pin to go through the assembly on the distal side. The ring-grip quick release pin is used instead of the cotter pin of the first embodiment to provide a locking member and the security of going entirely through both telescoping tubes. It provides a more positive locking feel and more convenient grip.

### BRIEF DESCRIPTION OF THE DRAWINGS

The present invention can best be understood in connection with the accompanying drawings. It is noted that the invention is not limited to the precise embodiments shown in drawings, in which:

FIG. 1 is a perspective view of the adjustable restraining stop assembly of this invention.

FIG. 2 is a side view detail showing the hook and loop layers used for mounting.

FIG. 3 is a front elevation of the assembly of FIG. 1 installed on a double hung window showing the open region at the top.

FIG. 3A is a front elevation of the same window and assembly as in FIG. 3, but the open region is now shown at the bottom; dashed lines indicate an alternate intermediate position.

FIG. 4 is a side view of an alternate embodiment restraining stop assembly using a ring-grip quick release pin.

### DETAILED DESCRIPTION OF THE INVENTION

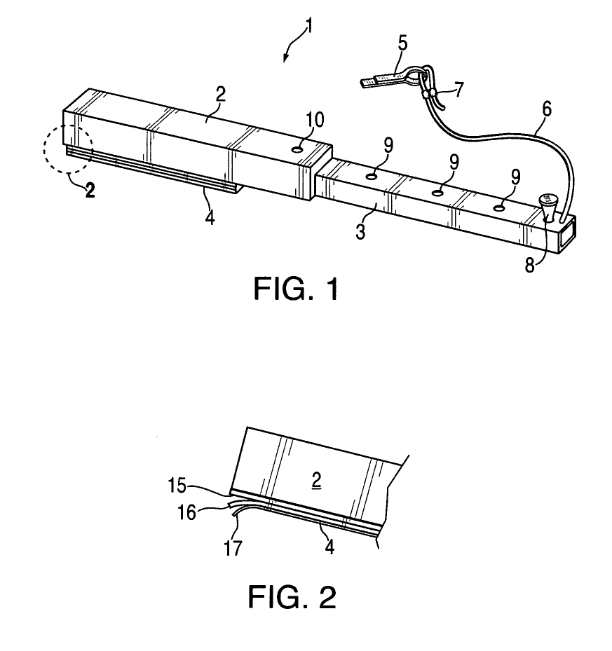

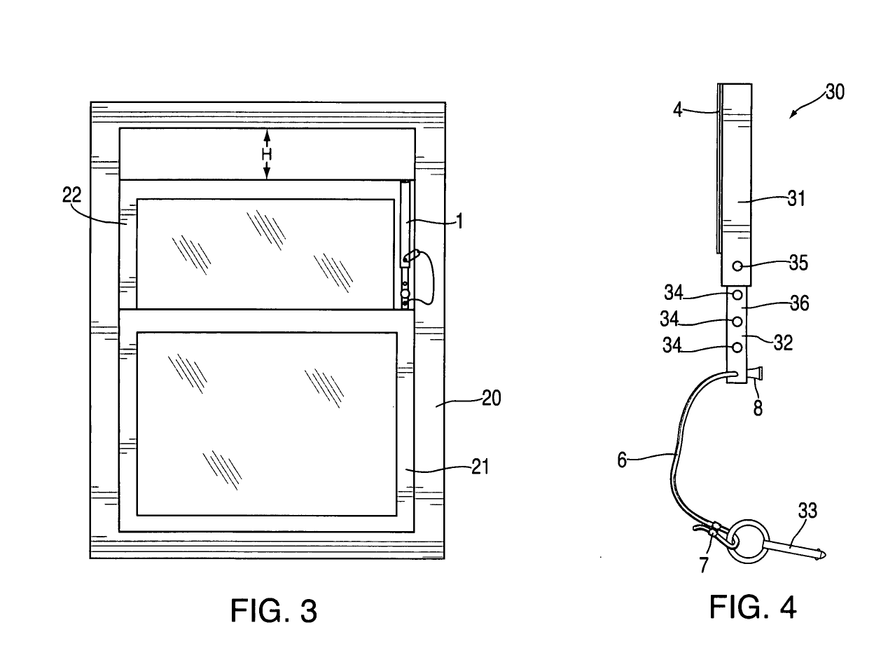

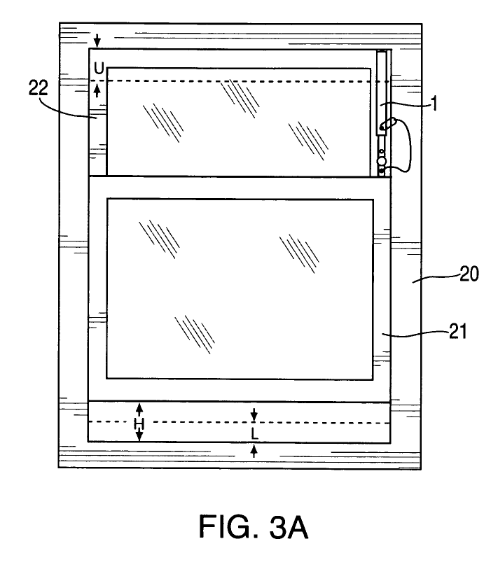

FIG. 1 shows adjustable restraining stop assembly 1 with outer tube 2, inner tube 3, and mounting hook and loop layer 4. A convenience knob 8 is attached near the distal end of inner tube 3. Adjustment is set by placing one of holes 9 on the front surface of inner tube 3 in registration with hole 10 on tube 2 and then inserting cotter pin 5 through hole 10 and into the desired hole 9 thereby locking the two tubes together. A lanyard line 6 is used to prevent losing cotter pin 5; it is retained in cotter pin 5 by using compression sleeve 7 to form a loop splice. FIG. 2 shows the various layers of the hook and loop layer 4. As supplied by the factory, the loop layer 15 is already bonded to tube 2. Layers 16 and 17, the hook layer and its release liner respectively, are also attached. To attach the assembly to the sash frame, the user must only remove release liner 17 exposing the layer of pressure sensitive adhesive and then just press assembly 1 against the window sash frame as shown in FIG. 3.

FIG. 3 shows window frame 20 with upper sash 22 and lower window sash 21. Assembly 1 is set at a desired position and locked. As shown, upper sash 22 is limited to an opening height of H, however the entire two-sash assembly can be moved upward any distance up to H to provide some ventilation at the bottom of the window. FIG. 3A shows the same window with assembly 1 at the same setting, but the open region (height H) is now at the bottom of window frame 20. Two dashed lines, one near the top of frame 20 and one near the bottom illustrate an alternate intermediate position with open regions both at the top and bottom. Lower open region height L and upper open region height U are related such that L+U=H if the setting of assembly 1 is unchanged.

An alternate embodiment adjustable restraining stop 30 is shown in FIG. 4. Here the adjustment holes 34 on inner tube 32 as well as matching hole 35 in outer tube 31 have been moved to the side. Also, adjustment holes 34 on tube 32 and hole 35 in tube 31 are now through holes penetrating both proximal and distal surfaces of the tubes. This permits ring-grip quick release pin 33 to pass entirely through the assembly with enough clearance at the distal end for the front locking balls. Since it may be more problematic to align one of holes 34 with hole 35 with the side position, line indicia on surface 36 on the front of tube 32 align with the bottom end of tube 31 to indicate registration positions.

In the foregoing description, certain terms and visual depictions are used to illustrate the preferred embodiment. However, no unnecessary limitations are to be construed by the terms used or illustrations depicted, beyond what is shown in the prior art, since the terms and illustrations are exemplary only, and are not meant to limit the scope of the present invention.

It is further known that other modifications may be made to the present invention, without departing the scope of the invention, as noted in the appended Claims.

We claim:

1. An adjustable restraining window stop assembly which permits a residential double hung window to be locked in a partially opened position to permit ventilation through the partial opening to restrain a window from opening beyond a desired extent without the aid of tools, comprising:
a stop including an outer tube with a telescoping inner tube;
said outer tube being mounted to a window sash by a removable fixation device;
a knob being attached near a distal end of said inner tube;
wherein an adjustment is set by placing a desired hole of a plurality of holes in said telescoping inner tube in registration with a single hole in said outer tube and then inserting an end of a fastener through said single hole of said outer tube and into said desired hole in said inner tube.

2. The adjustable restraining window stop assembly as in claim 1 wherein said removable fixation device is a large-area robust hook and loop pad, wherein further a respective hook portion is attached to the window sash frame via a pressure sensitive adhesive layer exposable upon peeling off a release liner layer;
wherein said assembly is removable to permit unencumbered opening of the window and is replaceable when required.

3. The adjustable restraining window stop assembly as in claim 2 further comprising:
said telescoping sections including a larger rectangular tubing section and a close-fitting inner rectangular tube of smaller dimension that telescopes from one end of said larger tubular section with frictional resistance.

4. The adjustable restraining window stop assembly as in claim 1 wherein said inner tube and said outer tube are plastic.

5. The adjustable restraining window stop assembly as in claim 4 wherein said plastic is polyvinylchloride (PVC),

6. The adjustable restraining window stop assembly as in claim 1 wherein said inner tube and said outer tube are metal.

7. The adjustable restraining window stop assembly as in claim 6 wherein said metal is aluminum.

8. The adjustable restraining window stop assembly as in claim 1 wherein said inner tube has a series of holes in a linear array on a front surface, opposite said mounting pad, while said outer tube has a single hole adjacent to its end that is in positional registration with any in the series of holes as said inner tube is pushed in or out of said outer tube.

9. The adjustable restraining window stop assembly as in claim 1 wherein said fastener is a cotter pin on a short lanyard, said cotter pin being used to lock in a desired assembly length by passing said cotter pin through said single hole in said larger outer tube and then through one of said holes in said inner tube.

11. The adjustable restraining window stop assembly as in claim 3 wherein said array of holes are on a front surface of said adjustable restraining window stop assembly.

12. The adjustable restraining window stop assembly as in claim 3 wherein said array of holes are on a side surface of said inner tube,
said single hole in said outer tube is on a side surface, and
all said holes are through holes penetrating both proximal and distal surfaces of said tubes.

13. The adjustable restraining window stop assembly wherein said assembly includes line indicia on a surface on said front of said smaller tube to align with a bottom end of said larger tube to indicate registration positions of said respective holes through which said removable fixation device is inserted.

14. The adjustable restraining window stop assembly as in claim 3 wherein by attaching said assembly to a frame of the top window sash near the top, a constrained opening can be adjusted at a top of the window, a bottom of the window or said constrained opening is shared between said top and said bottom of said window sash.

15. The adjustable restraining window stop assembly as in claim 3 wherein said assembly is set at a desired position and locked and said upper sash is limited to a predetermined opening height wherein said window sashes can be moved upward any distance up to said predetermined height to provide ventilation at a bottom of window.

16. The adjustable restraining window stop assembly as in claim 15 wherein said window is open at a top thereof.

17. The adjustable restraining window stop assembly as in claim 15 wherein said window is open at a bottom thereof.

18. The adjustable restraining stop assembly as in claim 15 wherein said window is open at both a top and a bottom thereof.

19. The adjustable restraining window stop assembly as in claim 12 wherein said fastener is quick release pin passing entirely through said assembly with enough clearance at a distal end thereof for respective front locking balls.

20. A method of providing an adjustable restraining window comprising the steps of:
providing an outer tube, an inner tube and mounting hook and loop layer on said outer tube;
providing a convenience knob near a distal end of said inner tube;
setting adjustment by placing a desired hole of an array of holes in said inner tube in registration with said hole in said outer tube and then inserting an end of a cotter pin through said single hole of said outer tube and into said desired hole;
providing a lanyard line to prevent losing said cotter pin 5;
attaching said stop with a hook and loop layer 4 to a window sash; and,
moving a sash of said window upward any distance up to a predetermined distance to provide ventilation at an upper and/or a lower portion of the window.
